(19) United States
(12) Patent Application Publication
(10) Pub. No.: US 2001/0011945 A1
(43) Pub. Date: Aug. 9, 2001

(54) DYNAMIC VIRTUAL PAGING METHOD AND APPARATUS

(76) Inventors: DAVID E. GILLILAND, LEAWOOD, KS (US); WILLIAM M. STORMS, KANSAS CITY, MO (US); PAULETTE A. THOMPSON, KANSAS CITY, MO (US)

Correspondence Address: S. H. DWORETSKY, AT&T CORPORATION, POST OFFICE BOX 4110, MIDDLETOWN, NJ, 07748

(21) Appl. No.: 09/049,257

(22) Filed: Mar. 27, 1998

(51) Int. Cl. G08B 5/22

(52) U.S. Cl. 340/7.46; 340/5.74

(57) ABSTRACT

A caller (11) may communicate a message to a predetermined group of paging devices (14₁-14ₘ) by entering a virtual Personal Identification Number associated with that group of devices, rather than a single actual device. Upon its receipt, a paging system (10) determines whether the caller-entered PIN constitutes a virtual PIN, and if so, then determines the paging devices within the associated group by accessing a database (28) containing such information. Once the predetermined group of paging devices is identified, the paging system communicates a caller-entered message thereto.

### TECHNICAL FIELD

This invention relates to a technique for communicating a message to a predetermined group of paging devices in response to a caller-entered Personal Identification Number (PIN).

### BACKGROUND ART

Notwithstanding the proliferation of cellular and PCS telephones, paging remains a popular method to communicate a message. In practice, a party seeking to communicate a message to a pager-equipped subscriber does so by dialing a telephone number, typically an 800 or 888 toll-free number of the paging services provider serving the subscriber. Upon receipt of such a call, the paging services provider prompts the caller to enter a Personal Identification Number (PIN) that identifies the subscriber. The caller then enters the PIN, either by entering the corresponding Dual-Tone Multi-Frequency (DTMF) signals via the key pad on the telephone set, or by speaking the digits of the subscriber's PIN for conversion into corresponding electrical signals. After receiving the PIN, the paging services provider prompts the caller to enter a numeric message, or in some instances, an alphanumeric message. Upon its receipt, the paging service transmits the caller-entered message to the subscriber for receipt on his/her pager.

In some instances, a caller may wish to communicate a message to a plurality of separate subscribers, each carrying a pager assigned an individual PIN. Presently, to communicate a message to each subscriber, the caller must separately enter the subscriber's PIN and numeric message, a very cumbersome process. Yet, another drawback associated with present day paging services is the requirement that within a particular organization, a subscriber may need to carry separate paging devices for separate functions. For example, an organization responsible for different maintenance functions may have separate paging devices assigned for each function. Thus, when different individuals must perform a particular maintenance function, they must exchange paging devices, an inconvenience to say the least.

Thus, there is need for a dynamic paging technique that is not subject to the aforementioned disadvantages of the prior art.

### BRIEF SUMMARY OF THE INVENTION

Briefly, the present invention provides a technique for communicating a caller-entered message to a predetermined group of paging devices in response to a caller-entered PIN. In accordance with the invention, a caller seeking to communicate a message to a predetermined group of paging devices does so by entering a PIN and a message to a paging system, typically by entering a DTMF signal, or combination of such signals, or a spoken command, or via an electronic signal, such as via e-mail. In response to the PIN from the caller, the paging system accesses a data base to determine if the entered PIN constitutes a Virtual Personal Identification Number (PIN), and if so, which actual paging devices personal identification numbers are associated with the Virtual PIN. The paging system then communicates the caller-entered message to each paging device associated with the Virtual PIN.

The technique of the invention affords the ability to signal a predetermined group of paging devices in response to a single caller-entered PIN. Moreover, the technique affords the opportunity to dynamically alter the predetermined group of paging devices by modifying the database to change the list of pages corresponding to the caller-entered virtual PIN.

### BRIEF DESCRIPTION OF THE DRAWING

FIG. 1 illustrates a block diagram of a paging system for practicing the technique of the invention.

### DETAILED DESCRIPTION

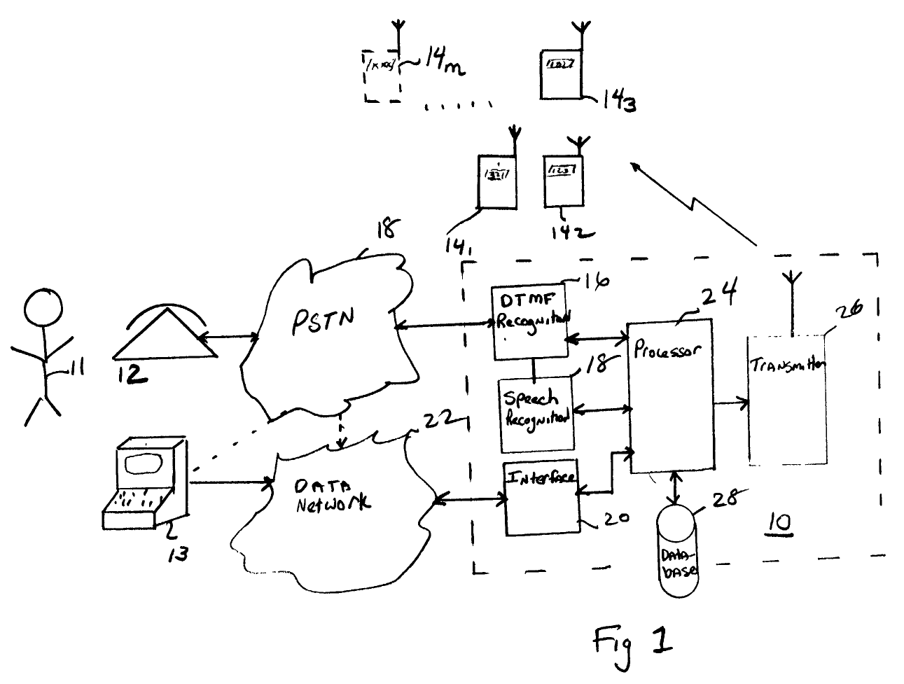

FIG. 1 illustrates a paging system 10, in accordance with a preferred embodiment of the invention for enabling a caller 11, using either a voice telephone set 12 or a computer/terminal 13 to communicate a message to predetermined group of paging devices 14₁-14ₘ (where m is a integer). The paging system 10 includes a Dual-Tone Multi-Frequency recognition circuit 16 connected to a Public Switched Telecommunications Network (PSTN) for receiving a telephone call from the caller 11 initiated through the telephone set 12. The DTMF recognition circuit 16 typically comprises a Voice Response Unit (VRU), such as the CONVERSANT™ VRU manufactured by Lucent Technologies, Inc., that has the capability of prompting the caller with a voice announcement to enter DTMF signals through the telephone set 12, and the capability to recognize such caller-entered DTMF signals.

In the illustrated embodiment, the paging system 10 also includes a speech recognition circuit 18 for receiving and interpreting spoken commands entered by the caller 11 and for translating such spoken commands into electrical signals. In practice, the speech recognizer circuit 18 is coupled to the DTMF recognition circuit 16 for processing spoken commands originally received from the called party. Typically, the voice prompt made by the DTMF recognition circuit 16 to the caller 11 requests that the caller enter the appropriate PIN number of the pager to be signaled by either pressing the appropriate touch pad digits on the telephone set 12 or by speaking the PIN. Should the caller speak the PIN rather than enter the corresponding string of DTMF signals, the DTMF recognition circuit 16 passes the spoken command to the speech recognition circuit 18 for processing.

Rather than enter a request through the telephone set 12, the caller could make his/her page request through the computer terminal 13 via an electronic signal, such as email or the like. The paging system 10 typically receives the page request from the terminal 13 at an interface 20 connected to the terminal through a data network 22. The terminal 13 may enjoy a direct connection with the network 22 or may connect to the network 22 through a dial-up connection via the PSTN 18.

The paging system 10 includes a processor 24 coupled to the DTMF recognition circuit 16, the speech recognition circuit 18 and the interface 20 for receiving a page request from the caller 11 entered via the telephone set 12 or via the terminal 13. In the past, the page request entered by the caller constituted a “real” PIN, corresponding to the actual identification number of a single paging device associated with the particular subscriber the caller sought to signal, together with a numeric or alphanumeric message for that single subscriber. In response to that caller-entered PIN, the processor 24 causes a transmitter 26 to broadcast the caller-entered message to the particular subscriber whose PIN the caller entered. Thus, to send the same message to a plurality of different subscribers, the caller previously had to separately enter each subscriber's PIN, a cumbersome process.

In accordance with the invention, the paging system 10 affords the caller 11 the capability of communicating a message to a predetermined group of the paging devices 14₁-14ₘ, such as the paging devices 14₁-14₃, for example, by enabling the caller to enter a “virtual” PIN corresponding to that group of devices. Such a virtual PIN does not correspond to any actual pager PIN. Rather, the virtual PIN represents a label or cross-reference to an entry in a database 28 that identifies a predetermined group of paging devices. The database 28 is connected to the processor 24. Upon receipt of the caller-entered PIN, the processor 24 accesses the database to determine whether the caller-entered PIN constitutes a virtual PIN or not. If, after accessing the database 28, the processor 24 determines that the caller initiated page request constitutes a “real” PIN, (i.e., the actual PIN of one of the paging devices 14₁-14ₘ), then the processor 24 causes the transmitter 26 to transmit a caller-entered message to the individual paging device identified by the caller-entered-entered PIN.

Now assume the caller 11 enters a virtual PIN. (In practice, a virtual PIN differs from an actual PIN, either by a different number of digits, a special character, such as “*”, or by a different numeric range, as compared to that of an actual PIN.) Upon receiving the caller-entered PIN, the processor 24 accesses the database 28 as before. A virtual PIN causes the database 28 to return to the processor 24 the actual pager PINs associated with such a virtual PIN. Thereafter, the processor 24 causes the transmitter to broadcast a caller-entered message to those paging devices whose PINs are associated with the caller-entered virtual PIN. Depending on the capability of the transmitter 26, the messages are either sent serially, or simultaneously.

The paging technique of the invention advantageously affords the ability to dynamically alter the actual PINs associated with each virtual PIN as desired. Typically, an individual, such as the caller 11, initially establishes a virtual PIN and associated list of corresponding actual paging device PINs by entering this information into the data base 28, either directly through the telephone 12 or the terminal 13, or via a request to the operator of the paging system 10 who would make such an entry in the database. As circumstances change, the caller 11 could modify the actual paging device PINs associated with a virtual PIN by adding, deleting and/or substituting one or more actual paging device PINs from the list associated with a virtual PIN. Thus, in an organization where different individuals have a variety of tasks that change on a dynamic basis, each individual need not exchange pagers when assigned different tasks. Rather, each task will have an associated virtual PIN, and the actual paging device PINs assigned to that virtual PIN will vary, depending on the individuals available for the particular task.

The foregoing discloses a technique for enabling a caller to communicate a message to a predetermined group of paging devices (14₁-14ₘ) in response to the entry of a single virtual PIN.

It is to be understood that the above-described embodiments are merely illustrative of the principles of the invention. Various modifications and changes may be made thereto by those skilled in the art which will embody the principles of the invention and fall within the spirit and scope thereof.

What is claimed is:

1. A method for communicating a caller-entered message to a predetermined group of paging devices in response to caller-entered Personal Identification Number (PIN), comprising the steps of:
receiving the caller-entered PIN and message;
accessing a database in response to the caller-entered PIN to determine whether the caller-entered PIN is a virtual PIN, and if so, then identifying the group of individual paging devices associated with the virtual PIN; and
communicating the caller-entered message to the group of individual paging devices associated with the virtual PIN.

2. The method according to claim 1 including the step of dynamically modifying the database to alter the group of individual paging devices associated with the virtual PIN.

3. The method according to claim 2 wherein additional paging devices are added to the group of individual paging devices associated with the virtual PIN.

4. The method according to claim 2 wherein paging devices are deleted from to the group of individual paging devices associated with the virtual PIN.

5. The method according to claim 2 wherein at least one paging device is substituted for another within the group of individual paging devices associated with the virtual PIN.

6. The method according to claim 1 wherein the step of accessing the database to determine whether the caller-entered PIN is a virtual PIN comprises the step of determining whether the caller-entered PIN has a particular number of digits.

7. The method according to claim 1 wherein the step of accessing the database to determine whether the caller-entered PIN is a virtual PIN comprises the step of determining whether the caller-entered PIN includes at least one special character.

8. The method according to claim 1 wherein the step of accessing the database to determine whether the caller-entered PIN is a virtual PIN comprises the step of determining whether the caller-entered PIN has is within a predetermined numeric range.

9. Apparatus for communicating a caller-entered message to a predetermined group of paging devices in response to a caller-entered Personal Identification Number (PIN), comprising:
means for receiving the caller-entered PIN and message;
a database containing list of virtual PINs and for each virtual PIN, a list of PINS of associated paging devices;
means responsive to the caller-entered PIN for accessing the datebase to determine whether the caller-entered PIN is a virtual PIN, and if so, the PINs of the paging devices associated with the caller-entered PIN; and
means for communicating the caller-entered message to the group of individual paging devices associated with the virtual PIN.

10. The apparatus according to claim 9 wherein said means for receiving the caller-entered PIN and message includes a DTMF recognition circuit.

11. The apparatus according to claim 10 wherein the means for receiving the caller-entered PIN and message includes a speech recognition circuit.

12. The apparatus according to claim 10 wherein means for receiving the caller-entered PIN and message includes an interface for receiving signals from a terminal.

13. The apparatus according to claim 9 wherein the means for accessing the database comprises a processor.

14. The apparatus according to claim 9 wherein the means for communicating the caller-entered message comprises a transmitter.
